(19) United States
(12) Patent Application Publication
(10) Pub. No.: US 2004/0057880 A1
(43) Pub. Date: Mar. 25, 2004

(54) Plasma reactor, method for its manufacture and a device for treating exhaust gases in internal combustion engines using the plasma reactor

(76) Inventors: Christoph Treutler, Wannweil (DE); Andreas Hachtel, Leinfelden-Echterdingen (DE); Thomas Schulte, Stuttgart (DE); Sascha Henke, Weil Der Stadt (DE); Martin Hruschka, Abstatt-Happenbach (DE); Ulrich Hasenkox, Ditzingen (DE); Susanne Lucas, Gerlingen (DE)

Correspondence Address: KENYON & KENYON, ONE BROADWAY, NEW YORK, NY, 10004, US

(21) Appl. No.: 10/606,404

(22) Filed: Jun. 25, 2003

(30) Foreign Application Priority Data
Jun. 29, 2002 (DE) 102 29 340.6

(51) Int. Cl. B01J 19/08; B05D 3/02

(52) U.S. Cl. 422/186.04; 427/383.1; 427/383.5

(57) ABSTRACT

A plasma reactor for treating exhaust gases of internal combustion engines is provided, the plasma reactor having a ceramic body with a plurality of channels running through it. A gas may be passed through a first set of channels, while a second set of channels contains an electrically conducting material such that a plasma is generated in the interior of the second set of channels by applying an electric voltage. Also, a method of manufacturing a plasma reactor is provided, whereby first a green ceramic body having a plurality of channels running through it is produced and sintered to form a ceramic body, and then an electrically conducting material is introduced into a second set of channels in the ceramic body.

### FIELD OF THE INVENTION

The present invention relates to a plasma reactor, a method for its manufacture and a device for treating exhaust gases of internal combustion engines using the plasma reactor according to the preamble of the independent claims.

### BACKGROUND INFORMATION

Because of statutory requirements, purification of exhaust gases is becoming increasingly important in automotive engineering. Plasma generating systems have also been developed to an increasing extent for exhaust gas post-treatment in motor vehicles. So far, however, no technology suitable for mass production is available.

German Patent No. 198 60 460 describes a recuperative radiation burner having a burner body in the form of a monolithic ceramic honeycomb having a checkerboard pattern of channels having a rectangular or square cross section running parallel to one another through the ceramic honeycomb. In addition, there are also known monolithic ceramic bodies having a honeycomb design in catalytic converters used in automotive engineering.

### SUMMARY

The plasma reactor according to the present invention has the advantage over the conventional plasma reactors that it is easily integrated into the exhaust line of a motor vehicle and is suitable for mass production. In addition, chemical processes are promoted due to the plasma generated in the gas and/or exhaust gas passing through the reactor during operation of such a plasma reactor, so that in combination with a conventional catalytic converter and/or particle filter in particular, these chemical processes permit extensive purification and/or efficient treatment of the exhaust, e.g., in downstream catalysts or filters. To this extent, the plasma reactor is suitable for use in a device for treatment of exhaust gases of internal combustion engines and in particular in mobile systems, such as those required for motor vehicles.

The method according to the present invention for manufacturing a plasma reactor has the advantage that it relies on existing manufacturing methods suitable for mass production.

The ceramic body of the plasma reactor may have a regular structure, e.g., a honeycomb or checkerboard structure of channels, which pass through the preferably monolithic ceramic body and extend parallel to one another.

The set of channels in the ceramic body which form the electrodes for igniting and/or maintaining the plasma may be arranged spatially at a constant distance from one another, and the dielectric between the electrodes and/or the discharge gap between the electrodes for the plasma, which is formed by a first portion of the channels crossing through the ceramic body, may have a uniform thickness.

To this extent, the ceramic body functions as a supporting structure and also as a dielectric in plasma generation and/or plasma discharge, so that a uniform, dielectrically hindered plasma discharge is achieved, and a plasma which burns uniformly and continuously may be produced, both electrodes being covered by a dielectric.

Covering the electrodes also offers protection of the electrodes in the exhaust gas which is to be post-treated, so there is little or no attack on the electrodes by the exhaust gas.

The electrodes of the plasma reactor may be triggered by an alternating voltage, e.g., a pulsed alternating voltage, preferably with alternating contacting of the electrodes or electrode planes. Conventional methods of igniting and/or maintaining a plasma may be used.

With regard to the introduction of electrically conducting material into a second set of the channels in the ceramic bodies which form the electrodes for the plasma discharge, a plurality of inexpensive methods are available for selection here. For example, introduction and/or generation of the electrodes, i.e., the introduction of the electrically conducting material into the particular channels, may take place by, e.g., sucking through and/or in, or forcing in and/or blowing in a paste containing metal or a slip which is convertible into an electrically conducting ceramic, through the particular portion of the channels, and subsequent conversion, e.g., firing, of the paste adhering in the particular channels or the slip adhering thereto may be performed to form the electrically conducting material. This achieves the result that the second set of the channels become at least largely coated with the paste or the slip on the inside, or are filled with it.

Another method of introducing the electrically conducting material into the second set of the channels, which function as the electrode for the plasma discharge, involves temporary sealing of a first set of the channels in whose interior the plasma is to be ignited, performing this sealing on at least one end, but possibly on both ends, and then immersing the ceramic body into a solution or a suspension containing a component which contains or may be converted into the electrically conducting material. Then after immersion, this component may be fired to yield the electrically conducting material, or this component is converted into the electrically conducting material by some other method.

Thus, on the whole, the method described above achieves the result that the second set of the channels which are to form the electrodes in generating the plasma are coated, e.g., homogeneously with the electrically conducting material on their inside or they are filled with it uniformly, i.e., completely.

The temporary sealing of the first set of the channels may be performed with the help of a wax, because it may be removed again particularly easily, e.g., by burning it out or melting it, after the electrically conducting material has been introduced into the particular channels.

Other methods of introducing the electrically conducting material into the ceramic body include the insertion of wires made of the electrically conducting material or, as an alternative, chemical or galvanic metallization of the inside of the channels in question. This metallization may be performed uniformly and completely on the inside of the particular channels. As an alternative, the particular channels may also be filled galvanically with the electrically conducting material.

An example of a particularly suitable metal for use as the electrically conducting material would be silver or an electrically conducting ceramic, such as a compound having the general composition LₓM¹_{y}M²_{z}O₃₊ᵥ where L may stand for trivalent metals such as Y, La or other elements from the group of lanthanides, M¹ may stand for divalent metals from the group of alkaline earth metals or some other monovalent or divalent element, and M² may stand for an element from the group of transition metals. The composition of this material is defined by the stoichiometric factors x, y, z and v. Compounds of the type La_{0.3}Sr_{0.7}MnO₃, La_{0.5}Sr_{0.5}CoO₃ or LaNiO₃, such as those known from the fields of electrodes for ceramic fuel cells, as magnetoresistive oxides or as electrodes for ferroelectric storage devices, may be used.

### BRIEF DESCRIPTION OF THE DRAWINGS

FIG. 1 shows a cross-sectional view of the ceramic body according to a first exemplary embodiment.

FIG. 2 shows a cross-sectional view of the ceramic body according to a second exemplary embodiment.

FIG. 3 shows a cross-sectional view of the ceramic body according to a third exemplary embodiment.

FIG. 4 shows a cross-sectional view of the ceramic body according to a fourth exemplary embodiment.

### DETAILED DESCRIPTION

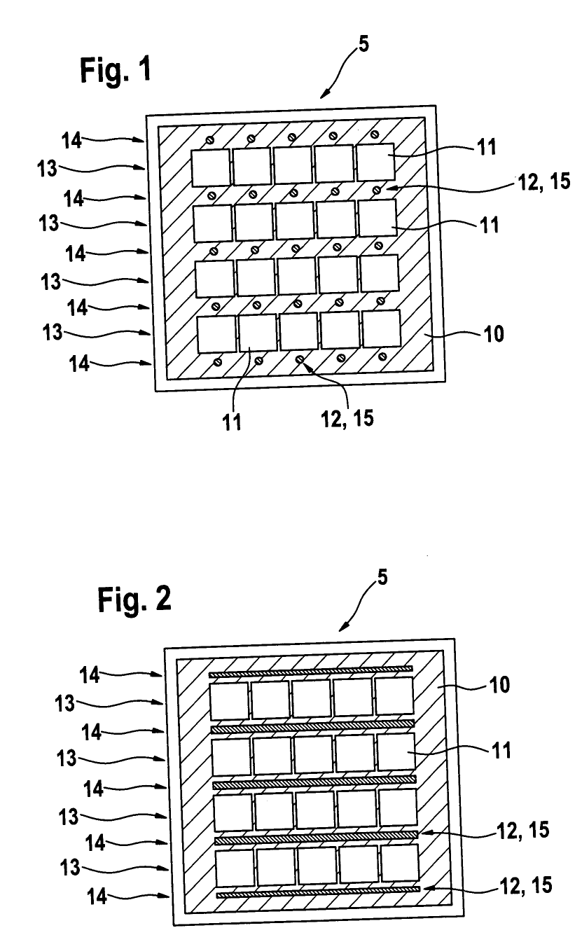

FIG. 1 shows a section through a ceramic body 10 having a plurality of channels 11, 12 running through it. A first set 13 of these channels forms gas-carrying channels 11 during operation, while a second set 14 of these channels are electrode-forming channels 12. Electrode-forming channels 12 are also filled with an electrically conducting material 15, e.g., a metal or an electrically conducting ceramic.

The shape of the electrodes and/or the cross section of the electrode-forming channels is/are largely freely selectable, i.e., the electrodes may be round or flat, as shown in FIG. 2, and thus may be optimized for the best shape of a plasma discharge in the interior of gas-carrying channels 11. The same thing is also true of the shape, i.e., cross section of channels 11, which are gas-carrying channels during operation.

On the end faces of ceramic body 10, electrically conducting material 15 is electrically connected to channels 11 by metallic contact decks that are printed there, for example. To prevent sparkover, the contact decks may also be overprinted with a ceramic insulation material.

Thus, on the whole, this yields a plasma reactor 5 in which a plasma is ignitable and sustainable by applying a suitable electric voltage, e.g., an alternating voltage or a pulsed voltage, to electrode-forming channels 12 and thus also to electrically conducting material 15 provided in adjacent channels 11, through which a gas passes, thereby providing a gas-passage through ceramic body 10.

According to FIG. 1, ceramic body 10 may be a monolithic honeycomb ceramic body made of aluminum oxide or zirconium oxide, for example. For effective functioning of plasma reactor 5, electrode-forming channels 12 may be at a constant distance from one another, and if the dielectric provided between electrode-forming channels 12, i.e., the material of ceramic body 10 in the example explained here, may have a uniform thickness. In addition, the thickness of gas-carrying channels 11, which function as a discharge gap, should be as uniform as possible for the plasma discharge.

From the standpoint of ease of fabrication, it is therefore advantageous for channels 11 of first set 13 of channels and channels 12 of second set 14 of channels to run parallel to one another and to pass through ceramic body 10. As shown in FIGS. 1 through 4, the channels may have, e.g., a regular, honeycomb or checkerboard structure.

Each gas-carrying channel 11 may also be provided with two electrode-forming channels 12, with the help of which the plasma may be ignited in the interior of gas-carrying channels 11.

According to FIG. 1, gas-carrying channels 11 may have a square cross section. Electrode-forming channels 12 may be situated such that two electrode-forming channels 12 are provided for each square gas-carrying channel 11, the channels being situated opposite one another centrally in the area of a side face of the square. Thus, according to FIG. 1, two electrodes act on the interior of one gas-carrying channel 11, each electrode being formed by a channel 12 which is filled with electrically conducting material 15.

FIG. 2 illustrates another exemplary embodiment, wherein electrode-forming channels 12 are designed as slotted channels filled with electrically conducting material 15. This yields plate-type electrodes. FIG. 2 also shows that each row of adjacent gas-carrying channels 11 is opposite two electro-deforming channels 12, and one electrode-forming channel 12 is situated between two rows of gas-carrying channels 11.

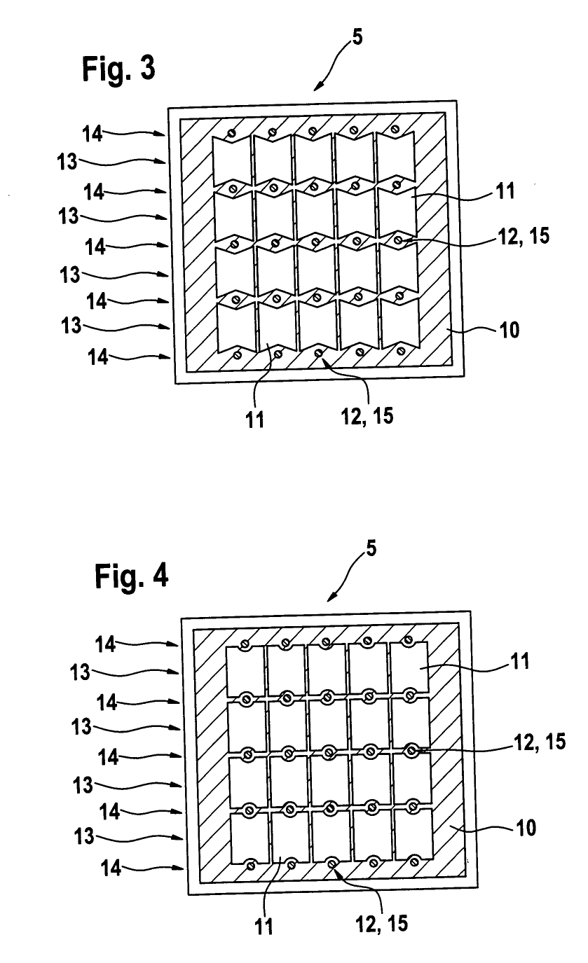

FIG. 3 illustrates another exemplary embodiment of the present invention. Gas-carrying channels 11 here are designed in the form of rectangles having two shorter-side faces with a V-shape, i.e., inclined inward in a triangular pattern. Again in this case, electrode-forming channels 12 are situated in the vicinity of these V-shaped side faces.

FIG. 4 illustrates another exemplary embodiment of the present invention, wherein two side faces of rectangular gas-carrying channels 11 have a semicircular inward indentation at the center.

The exemplary embodiments according to FIGS. 3 and 4 have the advantage that they have an enlarged flow cross section and thus a lower consumption of material at a constant firing distance, i.e., no voltage increase is necessary.

To manufacture a plasma reactor 5 and/or a ceramic body 10 according to one of the preceding exemplary embodiments, first a conventional extrusion method is used to produce a green ceramic body having a plurality of channels running through it. This green ceramic body is then sintered to form, on the whole, a monolithic ceramic body having a honeycomb or checkerboard structure, with the dimensions adjusted if necessary. At the same time, new paths of introducing electrically conducting material 15 into electrode-forming channels 12 have been taken in the production process used for plasma reactor 5 and, in contrast to the arrangement of channels in the ceramic body according to German Patent No. 198 60 460, optimized geometries and arrangements may be used for electrode-forming channels 12 and/or gas-carrying channels 11 to reduce the consumption of material for the electrodes, i.e., electrically conducting material 15, and to ensure that ignition of a plasma discharge is facilitated in the interior of gas-carrying channels 11.

Thus, with the help of a conventional extrusion method and by producing a green ceramic body which is sintered to form ceramic body 10, a monolithic ceramic body having gas-carrying channels 11 is obtained first, its shape corresponding to one of the exemplary embodiments according to FIGS. 1 through 4, and electrode-forming channels 12 according to one of the exemplary embodiments shown in FIGS. 1 through 4 may be formed. Electrode-forming channels 12 are then coated or filled at least partially, e.g., completely, with electrically conducting material 15 in their interior before the resulting electrodes are wired together in pairs, so that it is possible to ignite and maintain a plasma in the interior of gas-carrying channels 11 in which an exhaust gas is carried when plasma reactor 5 is used in a device for treating exhaust from combustion engines, e.g., in a motor vehicle.

In comparison with a plasma reactor produced from individual layers or plates, the method according to the present invention explained here thus provides a monolithic structure of ceramic body 10 in which no bonding technique is necessary, e.g., for stacking individual layers.

Therefore, the method described here is particularly suitable for the rapid and inexpensive production of a sturdy, vibration-resistant plasma reactor 5, e.g., for installation in the exhaust line of a motor vehicle. In addition, plasma reactor 5 has a comparatively large free cross section of gas-carrying channels 11, and the possible forms of gas-carrying channels 11 and/or electrode-forming channels 12 may be easily varied because of the extrusion method used.

Finally, consumption of electrically conducting material 15, e.g., a noble metal such as silver, is comparatively minor because the electrically conducting material 15 is introduced into ceramic body 10 only after it is sintered, i.e., as part of a post-firing, so that no high-melting and/or expensive noble metals from the platinum group are necessary for electrically conducting material 15, i.e., for introduction of the electrodes. Furthermore, through an appropriate design of the cross section of gas-carrying channels 11 and/or electrode-forming channels 12 and their placement, it is possible to vary the field strength distribution and homogeneity of the electric field created when the electric voltage is applied over a very wide range, and to optimize it with regard to the most uniform possible plasma discharge burning without interference in the interior of gas-carrying channels 11.

According to the first exemplary embodiment for introducing electrically conducting material 15 into the interior of electrode-forming channels 12 which have been formed by sintering the ceramic body 10, the introduction of a paste containing a metal, e.g., a conventional silver paste, into electrode-forming channels 12 may take place by sucking in or through, or forcing in or blowing in the paste, so that the paste adheres to the walls in the interior of channels 12 or fills channels 12. Then the paste in the interior of channels 12 is converted to electrically conducting material 15, e.g., silver, preferably by firing. This achieves the result that channels 12 of the second set 14 of channels are coated as homogeneously as possible with the paste on their insides, or they are filled with the paste as completely as possible.

Instead of a paste containing metal, an electrically conducting ceramic may also be used as electrically conducting material 15. In this case, instead of a paste, a slip may be used first, which is introduced into electrode-forming channels 12 and then converted to the electrically conducting ceramic by firing.

A second method for introducing electrically conducting material 15 into second set 14 of channels 12 involves temporarily sealing first set 13 of channels 11 on at least one end and immersing ceramic body 10 in a solution (or even a suspension) containing a component which contains, or is convertible into, electrically conducting material 15.

Temporary sealing of the first set of channels may be performed with a wax, which is removed after conclusion of the introduction of electrically conducting material 15 into second set 14 of channels 12, e.g., by burning it or melting it.

After immersion of ceramic body 10 into the solution or suspension, the component which is convertible into electrically conducting material 15 is converted by, e.g., firing, so that the electrically conducting material is formed. This results in a homogeneous coating of the inside of electrode-forming channels 12 with electrically conducting material 15. As an alternative, however, this method may also be used, depending on the concentration of the solution or suspension, to completely fill electrode-forming channels 12 with electrically conducting material 15.

A third exemplary embodiment for introducing electrically conducting material 15 into electrode-forming channels 12 involves pulling wires made of electrically conducting material 15 into these channels.

A fourth method of introducing electrically conducting material 15 into second set 14 of channels 12 involves chemical or galvanic metallization of the inside of particular channels 12.

What is claimed is:

1. A plasma reactor, comprising:
a ceramic body including a plurality of channels running through the ceramic body, a first set of channels facilitating passage of gas through the ceramic body, and a second set of channels including an electrically conducting material;
wherein a plasma is at least one of ignitable and sustainable in the interior of at least some channels of the second set of channels by applying an electric voltage to the at least some channels of the second set of channels.

2. The plasma reactor according to claim 1, wherein at least one of:
a) the channels of the first set of channels extend parallel to one another and traverse the ceramic body; and
b) the channels of the second set of channels extend parallel to one another and traverse the ceramic body.

3. The plasma reactor according to claim 2, wherein at least one of:
a) the channels of the second set of channels have a regular structure; and
b) the channels of the first set of channels have a regular structure.

4. The plasma reactor according to claim 3, wherein the regular structure is one of a honeycomb structure and a checkerboard structure.

5. The plasma reactor according to claim 1, wherein the channels having the electrically conducting material form electrodes, and wherein two channels having the electrically conducting material are assigned to each channel of the first set of channels.

6. The plasma reactor according to claim 1, wherein one of:
the channels of the second set of channels are filled with the electrically conducting material;
the channels of the second set of channels are coated on their inside with the electrically conducting material; and
wires formed of the electrically conducting material are introduced into the channels of the second set of channels.

7. The plasma reactor according to claim 6, wherein the electrically conducting material is one of a metal or conducting ceramic.

8. The plasma reactor according to claim 6, wherein the channels of the second set of channels are coated on their inside by metallization at the surface.

9. A method for manufacturing a plasma reactor, comprising:
producing a green ceramic body having a first and second set of channels running through the green ceramic body;
sintering the green ceramic body to form a ceramic body; and
after sintering, introducing an electrically conducting material into the second set of channels in the ceramic body;
whereby, when a gas passed through the first set of channels in the ceramic body and an electric voltage is applied to at least some of the channels of the second set of channels, a plasma is generated in the interior of at least some of the channels of the first set of channels.

10. The method according to claim 9, wherein the green ceramic body is produced using extrusion.

11. The method according to claim 9, wherein the electrically conducting material is introduced into the second set of channels by one of sucking through, sucking in, forcing in and blowing in one of a paste and a slip which is convertible into an electrically conducting ceramic, and subsequently firing the one of the paste and the slip to form the electrically conducting material.

12. The method according to claim 11, wherein the paste contains a metal.

13. The method according to claim 11, wherein the channels of the second set of channels are at least partially coated on their insides with one of the paste and the slip.

14. The method according to claim 13, wherein the channels of the second set of channels are filled with one of the paste and the slip.

15. The method according to claim 9, wherein introducing the electrically conducting material into the second set of channels includes temporarily sealing the first set of channels on at least one end and immersing the ceramic body in one of a solution and a suspension including a component that one of contains and is convertible into the electrically conducting material.

16. The method according to claim 15, further comprising:
converting the component into the electrically conducting material by firing.

17. The method according to claim 15, wherein the channels of the second set of channels are at least partially coated on their inside with the electrically conducting material.

18. The method according to claim 15, wherein the temporary sealing is performed using a wax which is removed after introducing the electrically conducting material into the second set of channels.

19. The method according to claim 15, wherein the wax is removed by one of burning and melting.

20. The method according to claim 9, wherein introducing the electrically conducting material into the second set of channels includes inserting wires one of containing and made of electrically conducting material.

21. The method according to claim 9, wherein introducing the electrically conducting material into the second set of channels includes one of chemical and galvanic metallization of insides of the second set of channels.

22. The method according to claim 9, wherein the electrically conducting material includes one of an electrically conducting ceramic and a metal.

23. The method according to claim 22, wherein the metal includes silver.
